(19) United States
(12) Patent Application Publication
(10) Pub. No.: US 2007/0151408 A1
(43) Pub. Date: Jul. 5, 2007

(54) Electric control mechanism for vehicle light unit

(76) Inventors: Wei-Jen Chen, Tainan (TW); Ming-Shan Kuo, Tainan (TW); Hsiang-Chen Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/255,006

(22) Filed: Oct. 21, 2005

(51) Int. Cl. G05G 1/00

(52) U.S. Cl. 74/586

(57) ABSTRACT

An electric control mechanism for light unit includes a motor which has a driving member connected to an output shaft of the motor and an adjust rod is connected to the driving member which drives the adjust rod to move linearly. The adjust rod is connected to the light unit. The motor is received in a motor case and a cap is mounted to the motor case. The adjust rod movably extends through the cap. A variable resistance has a slide member which is connected tot eh adjust rod so that when the adjust rod is moved, the slide member moves with the adjust rod so that the control circuit detects the change of resistance. The control circuit may adjust the light unit according to the value of the resistance.

### FIELD OF THE INVENTION

The present invention relates to an electric control mechanism which uses change of resistance of a variable resistance to detect the position of vehicle light unit.

### BACKGROUND OF THE INVENTION

A conventional control mechanism for controlling head light unit of vehicles is shown in FIG. 1 and generally includes a manual control device which is connected to a control circuit and an electric adjust device is connected to the control circuit and the head light unit is connected to the electric adjust device. Therefore, the driver can operate the manual control device to activate the electric adjust device via the control circuit to adjust the head light unit. However, the driver can acknowledge the position of the head light unit during driving so that he has to operate the manual control device while driving and this is dangerous. Besides, every time the car is started, the electric adjust device is forced to be initialized so that the driver has to re-adjust the head light unit again.

The present invention intends to provide an electric control mechanism which has a variable resistance which changes the resistance when the head light is moved so that the control circuit detects the exact position of the head light unit by the value of the resistance. In other words, the electric control mechanism is able to automatically adjust the head light unit according to the resistance of the variable resistance.

### SUMMARY OF THE INVENTION

The present invention relates to an electric control mechanism for light unit, the electric control mechanism comprises a motor received in a motor case and a driving member is fixed to an output shaft of the motor. An adjust rod is connected to the driving member which drives the adjust rod to move linearly. A cap is mounted to the motor case and the adjust rod movably extends through a passage of the cap. A variable resistance has a slide member which is connected to the adjust rod.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates a conventional control mechanism for controlling head light unit of vehicles;

FIG. 2 is a perspective view to show the light unit with the electric control mechanism of the present invention;

FIG. 3 is an exploded view to show the light unit with the electric control mechanism of the present invention;

FIG. 4 is a cross sectional view to show a position of the slide member of the variable resistance;

FIG. 5 illustrates the flow chart of the electric control mechanism of the present invention, and

FIG. 6 is a cross sectional view to show another position of the slide member of the variable resistance.

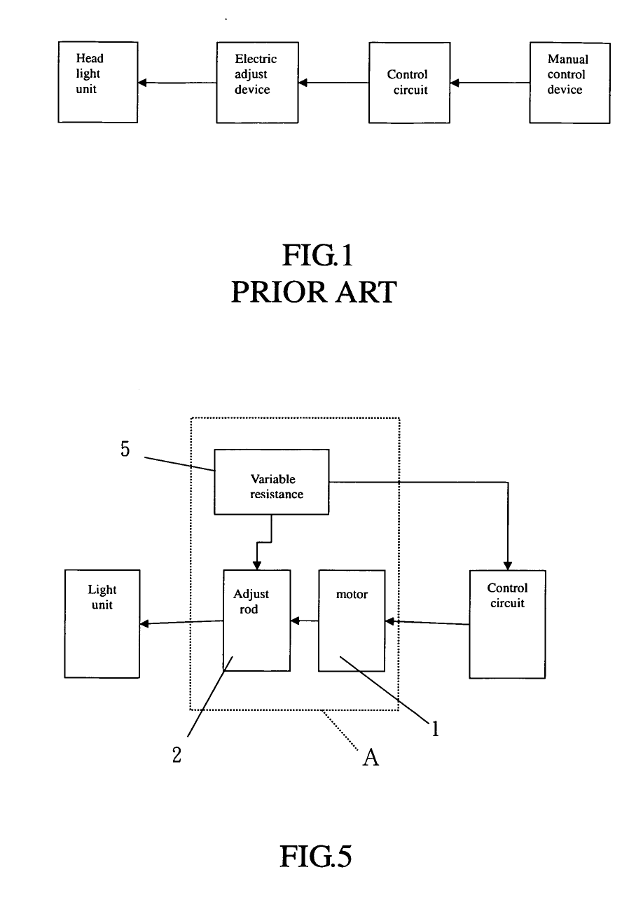

### DETAILED DESCRIPTION OF THE PREFERRED EMBODIMENT

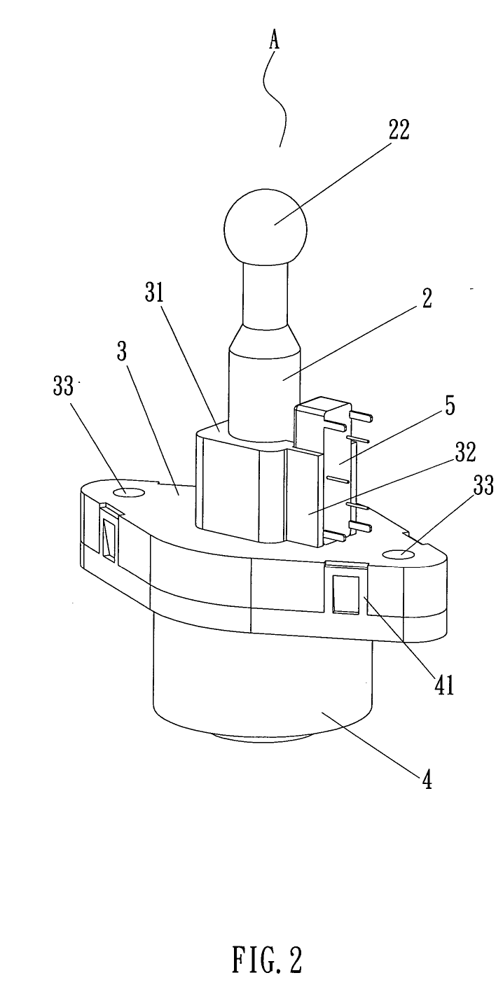

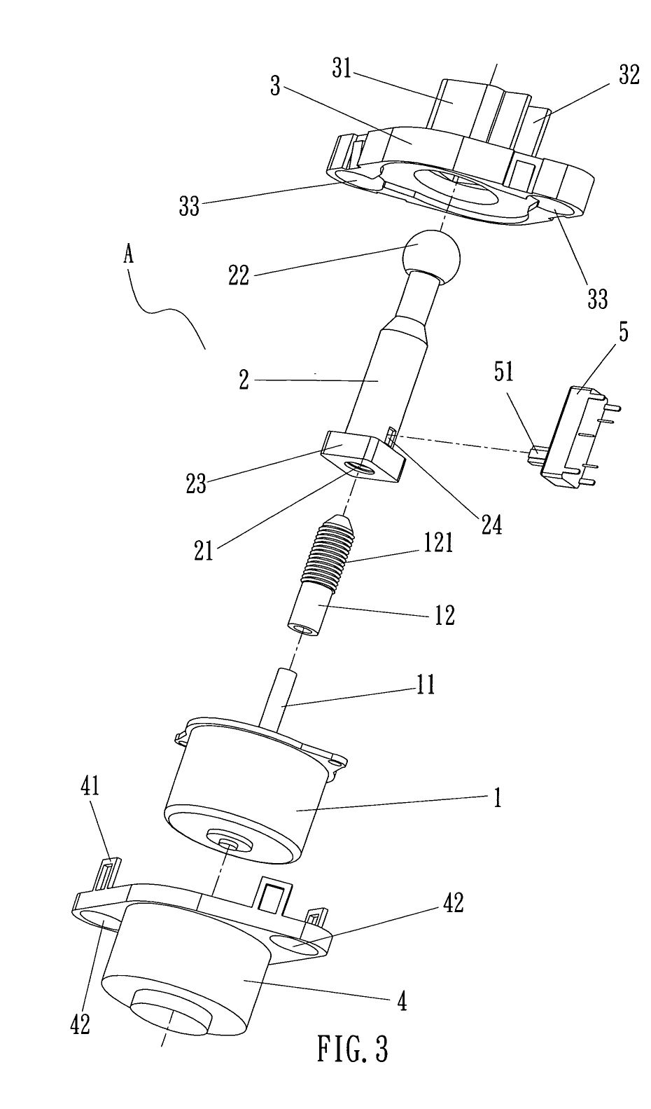

Referring to FIGS. 2 to 5, the electric control mechanism “A” for light unit of the present invention comprises a motor 1 having an output shaft 11 and the motor 1 is received in a motor case 4. A driving member 12 is fixed to the output shaft 11 and includes a threaded hole 21. An adjust rod 2 has a flange 23 at a first end thereof and a sphere 22 is connected to a second end thereof. A threaded hole 21 is defined axially in the first end of the adjust rod 2. The driving member 12 includes an outer threaded section 121 which is threadedly engaged with the threaded hole 21.

A cap 3 is mounted to the motor case 4 and includes two second holes 33 which are in alignment with second holes 42 defined through the motor case 4 so that connection members such as bolts may extend through the first and second holes 33, 42 to connect the motor case 4 and the cap 3 together. The motor case 4 further includes a plurality of connection hooks 41 which are hooked to a periphery of the cap 3. The adjust rod 2 movably extends through a passage 31 of the cap 3 and a light unit (not shown) is pivotably connected to the sphere 22.

A variable resistance 5 is engaged with a guide path 32 on the cap 3 and has a slide member 51 which is engaged with an engaging recess 24 defined in an outer periphery of the adjust rod 2.

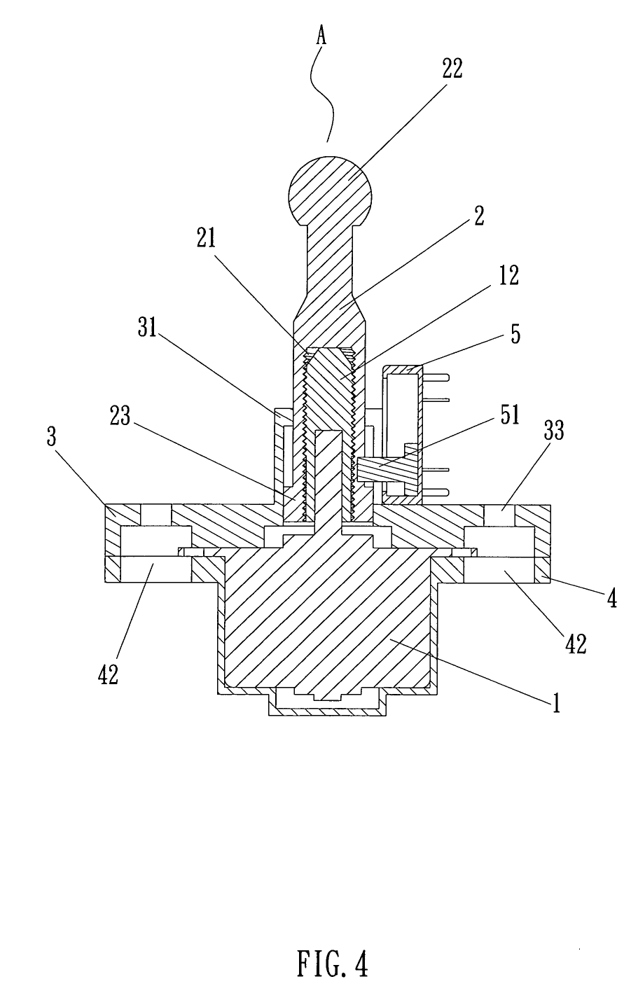

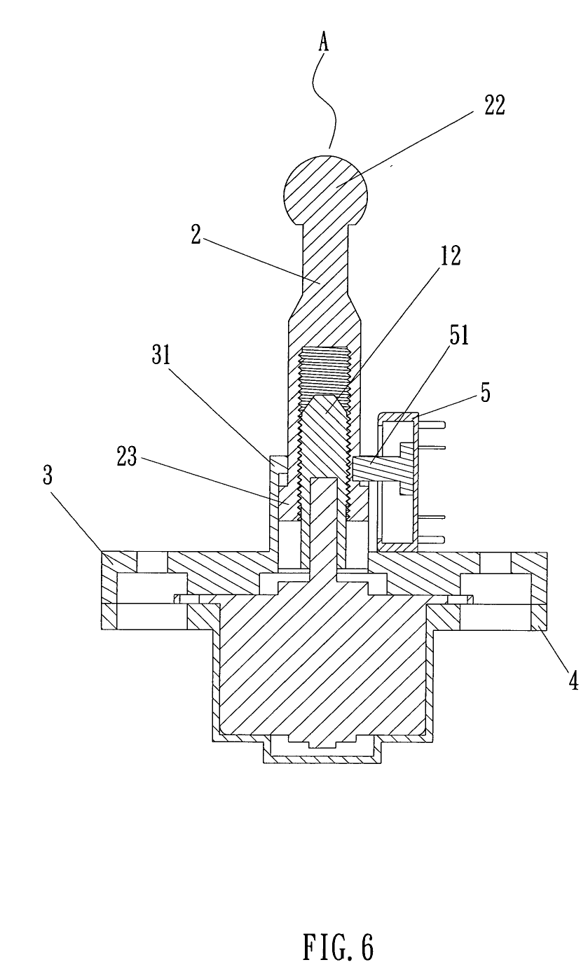

Referring to FIGS. 4 and 6, when the motor 1 is activated, the output shaft 11 and the driving member 12 are co-rotated with each other. The rotation of the driving member 12 moves the adjust rod 2 linearly so as to adjust the light unit. The slide member 51 engaged with the engaging recess 24 of the adjust rod 2 moves with the adjust rod 2 so that the value of the resistance changes. The control circuit detects the change of resistance so as to know the position of the light unit. In other words, the control circuit can also adjust the position of the light unit by comparing the current resistance value and a pre-set resistance value.

The control circuit can be cooperated with other control functions by setting different resistance values for different situations so that the user may set the light unit to a specific operation mode by comparing the current resistance value and the pre-set resistance value and accordingly move the adjust rod 2.

While we have shown and described the embodiment in accordance with the present invention, it should be clear to those skilled in the art that further embodiments may be made without departing from the scope of the present invention.

What is claimed is:

1. An electric control mechanism for light unit, comprising:
a motor having an output shaft;
a driving member fixed to the output shaft;
an adjust rod connected to the driving member which drives the adjust rod to move linearly;
a motor case receiving the motor therein and a cap mounted to the motor case, the adjust rod movably extending through a passage of the cap, and
a variable resistance having a slide member which is connected to the adjust rod.

2. The mechanism as claimed in claim 1, wherein the cap includes a guide path and the variable resistance is engaged with the guide path.

3. The mechanism as claimed in claim 1, wherein the adjust rod includes an engaging recess defined in an outer periphery thereof and the slide member is engaged with the engaging recess.

4. The mechanism as claimed in claim 1, the adjust rod includes a threaded hole and the driving member includes an outer threaded section which is threadedly engaged with the threaded hole.

5. The mechanism as claimed in claim 1, wherein the motor case includes a plurality of connection hooks which are hooked to a periphery of the cap.
